(19) United States
(12) Patent Application Publication
(10) Pub. No.: US 2013/0335394 A1
(43) Pub. Date: Dec. 19, 2013

(54) DRIVING CIRCUIT OF AN ORGANIC LIGHT EMITTING DEVICE AND METHOD OF OPERATING A DRIVING CIRCUIT OF AN ORGANIC LIGHT EMITTING DEVICE

(71) Applicants: Bo-Jhang Sun, Kaohsiung City (TW); Chin-Hai Huang, Taoyuan County (TW); Kuan-Yu Chen, Taoyuan County (TW); Szu-Chi Huang, Changhua County (TW)

(72) Inventors: Bo-Jhang Sun, Kaohsiung City (TW); Chin-Hai Huang, Taoyuan County (TW); Kuan-Yu Chen, Taoyuan County (TW); Szu-Chi Huang, Changhua County (TW)

(21) Appl. No.: 13/585,858

(22) Filed: Aug. 15, 2012

(30) Foreign Application Priority Data
Jun. 15, 2012 (TW) 101121543

(51) Int. Cl. G06F 3/038

(52) U.S. Cl. 345/212

(57) ABSTRACT

A driving circuit of an organic light emitting device includes a switch module, a capacitor, and a driving unit. The switch module includes a first switch unit and a second switch unit. The first switch unit is coupled to a data line. The second switch unit is coupled to the organic light emitting device. During a programming period, the first switch unit is turned on and the second switch unit is turned off; and during an emission period, the first switch unit is turned off and the second switch unit is turned on. The capacitor is coupled to the first switch unit for being charged to a data voltage according to a data current of the data line during the programming period. The driving unit is used for generating a driving current to drive the organic light emitting device according to the data voltage during the emission period.

### BACKGROUND OF THE INVENTION

1. Field of the Invention

The present invention relates to a driving circuit of an organic light emitting device and a method of operating a driving circuit of an organic light emitting device, and particularly to a driving circuit of an organic light emitting device and a method of operating a driving circuit of an organic light emitting device that can utilize current programming to make a driving current generated by the driving circuit be equal to a data current during an emission period, and be independent of any process parameter of a thin film transistor.

2. Description of the Prior Art

Please refer to FIG. 1 and FIG. 2. FIG. 1 is a diagram illustrating a driving circuit 100 of an organic light-emitting diode according to the prior art, where the driving circuit 100 is a driving circuit capable of voltage programming, and FIG. 2 is a diagram illustrating an operation timing of the driving circuit 100. As shown in FIG. 1 and FIG. 2, at a period T1 (a programming period), a scan signal VSCAN of a scan line SL is enabled, so a transistor M1 is turned on, resulting in a capacitor CS being charged to a corresponding voltage according to a data voltage VDATA of a data line DL. At a period T2 (an emission period), the scan signal VSCAN of the scan line SL is disabled, so the transistor M1 is turned OFF. Meanwhile, a transistor M2 generates a driving current ILED according to the corresponding voltage stored in the capacitor CS to drive an organic light-emitting diode OLED, where a voltage VDD is a supply voltage provided to the transistor M2. In addition, the driving current ILED is generated according to equation (1):

ILED=K(V_{GSM2}−V_{THM2})² (1)

As shown in equation (1), K is a process parameter of the transistor M2, V_{GSM2} is a gate-source voltage of the transistor M2, and V_{THM2} is a threshold voltage of the transistor M2.

Because the driving circuit 100 directly converts the data voltage VDATA of the data line DL into the driving current ILED to drive the organic light-emitting diode OLED, the driving circuit 100 has disadvantages as follows:

First, attenuation of a voltage VDD:

Please refer to FIG. 3. FIG. 3 is a diagram illustrating a display 300. As shown in FIG. 3, a power source 302 is used for providing the voltage VDD to a plurality of pixels of a display panel 304. Because a power line coupled between the power source 302 and any pixel of the plurality of pixels has impedance, a pixel (e.g. a pixel 3042) coupled to an end of a power line may suffer the attenuation of the voltage VDD. Thus, because the pixel 3042 suffers the attenuation of the voltage VDD, the attenuation of the voltage VDD can influence a driving current generated by the pixel 3042 for driving an organic light-emitting diode thereof, resulting in the display panel 304 having mismatch luminance. The mismatch luminance is especially serious on large-scaled display panels and display panels with P-type pixel driving circuits.

Second, threshold voltage shifts of transistors of each pixel:

Because pixel driving circuits of the display panel 304 can be composed of different type transistors (e.g. amorphous silicon (A-Si) thin film transistors, polysilicon (Poly-Si) thin film transistors, low temperature polysilicon (LTPS) thin film transistors, organic thin film transistors (OTFTs), or metal oxide thin film transistors (Oxide TFTs)), processes and device characteristics thereof are also different. Thus, because different processes and device characteristics may make transistors have different threshold voltages, the display panel 304 may also suffer the mismatch luminance.

Third, an aging problem of an organic light-emitting diode:

Because the voltage VDD is provided to organic light-emitting diodes of the display panel 304 for a long time, a voltage drop of each organic light-emitting diode of the display panel 304 is gradually increased, resulting in luminance of the organic light-emitting diode being significantly degraded.

Therefore, the driving circuit 100 is not a good driving circuit for an organic light-emitting diode.

### SUMMARY OF THE INVENTION

An embodiment provides a driving circuit of an organic light emitting device. The driving circuit includes a switch module, a capacitor, and a driving unit. The switch module includes a first switch unit and a second switch unit. The first switch unit is coupled to a data line. The second switch unit is coupled to the organic light emitting device, where the first switch unit is turned on and the second switch unit is turned off during a programming period; and the first switch unit is turned off and the second switch unit is turned on during an emission period. The capacitor is coupled to the first switch unit for being charged to a data voltage according to a data current of the data line during the programming period. The driving unit is coupled to the capacitor and the second switch unit for generating a driving current to drive the organic light emitting device according to the data voltage during the emission period.

Another embodiment provides a method of operating a driving circuit of an organic light emitting device, where the driving circuit comprising a switch module, a capacitor, and a driving unit, the switch module includes a first switch unit and a second switch unit, the first switch unit includes a first transistor and a second transistor, the second switch unit includes a third transistor, and the driving unit includes a fourth transistor. The method includes turning on the first switch unit, turning off the second switch unit, and charging the capacitor to a data voltage according to a data current of a data line during a programming period; and turning off the first switch unit, turning on the second switch unit, and the driving unit generating a driving current to drive the organic light emitting device according to the data voltage during an emission period.

The present invention provides a driving circuit of an organic light emitting device and a method of operating a driving circuit of an organic light emitting device. The driving circuit and the method utilize current programming to make a driving current generated by the driving circuit during an emission period be equal to a data current, and be independent of any process parameter of a thin film transistor. Because the driving current generated by the driving circuit during the emission period is equal to the data current, and is independent of any process parameter of the thin film transistor, the present invention has advantages as follows: first, the present invention can compensate a threshold voltage shift of the thin film transistor of the driving circuit; second, the present invention can compensate an aging problem of the organic light emitting device; third, the present invention can compensate carrier mobility non-uniformity of the thin film transistor carrier; fourth, the present invention can compensate voltage attenuation of a power line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a driving circuit of an organic light-emitting diode according to the prior art.

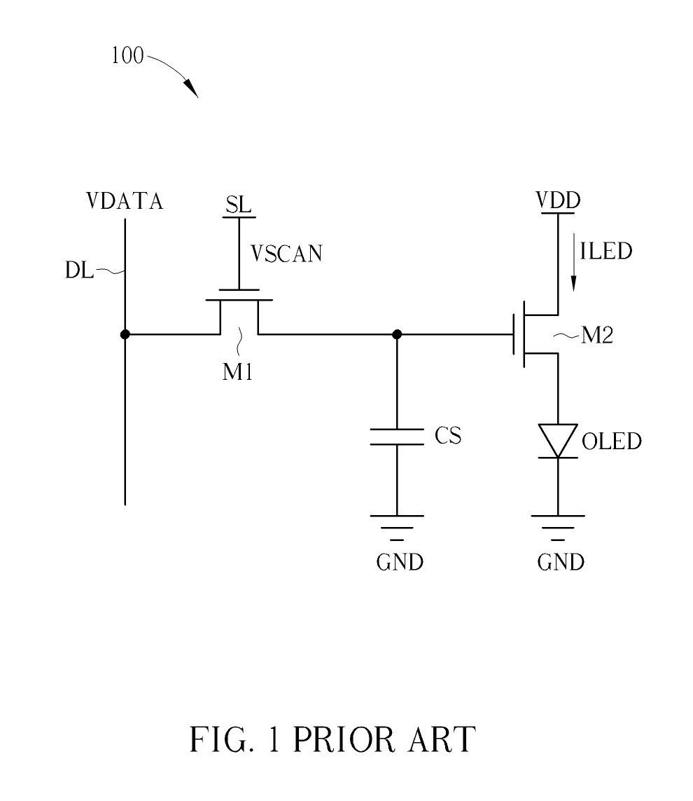

FIG. 2 is a diagram illustrating an operation timing of the driving circuit.

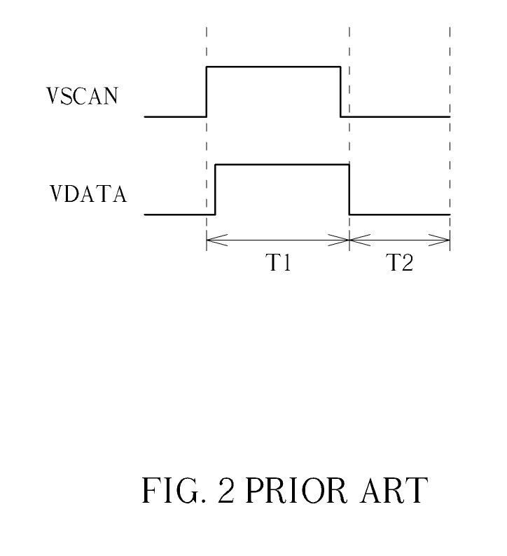

FIG. 3 is a diagram illustrating a display.

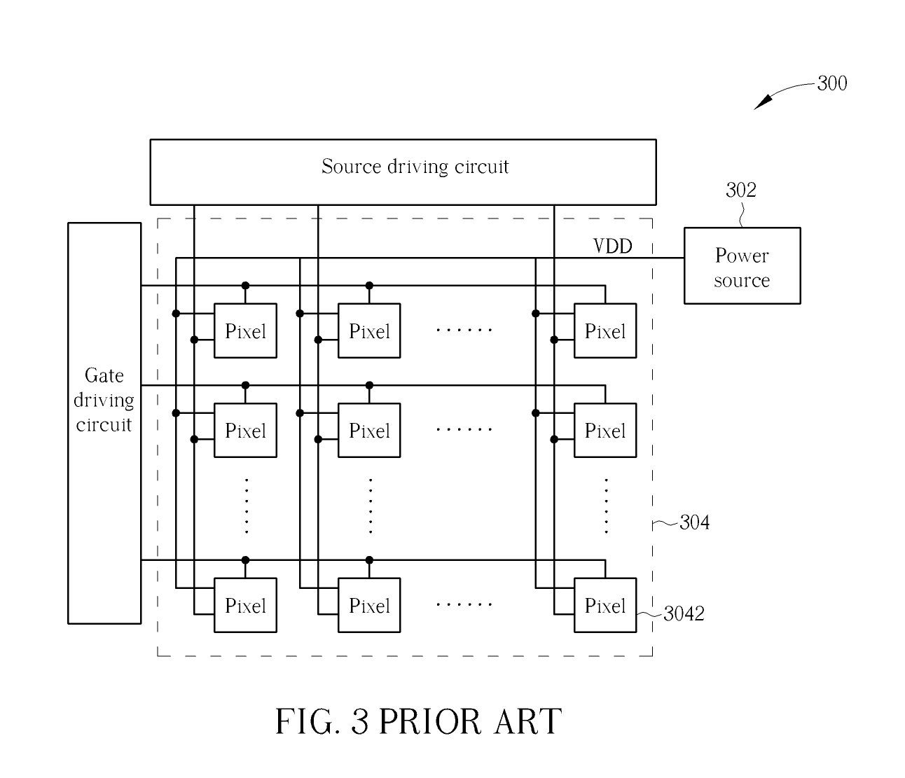

FIG. 4 is a diagram illustrating a driving circuit of an organic light emitting device according to an embodiment.

FIG. 5 is a diagram illustrating an operation timing of the driving circuit.

FIG. 6 is a diagram illustrating an equivalent circuit of the driving circuit during the programming period.

FIG. 7 is a diagram illustrating an equivalent circuit of the driving circuit during the emission period.

FIG. 8 is a diagram illustrating a driving circuit of an organic light emitting device according to another embodiment.

FIG. 9 is a diagram illustrating an operation timing of the driving circuit.

FIG. 10 is a flowchart illustrating a method of operating a driving circuit of an organic light emitting device according to another embodiment.

### DETAILED DESCRIPTION

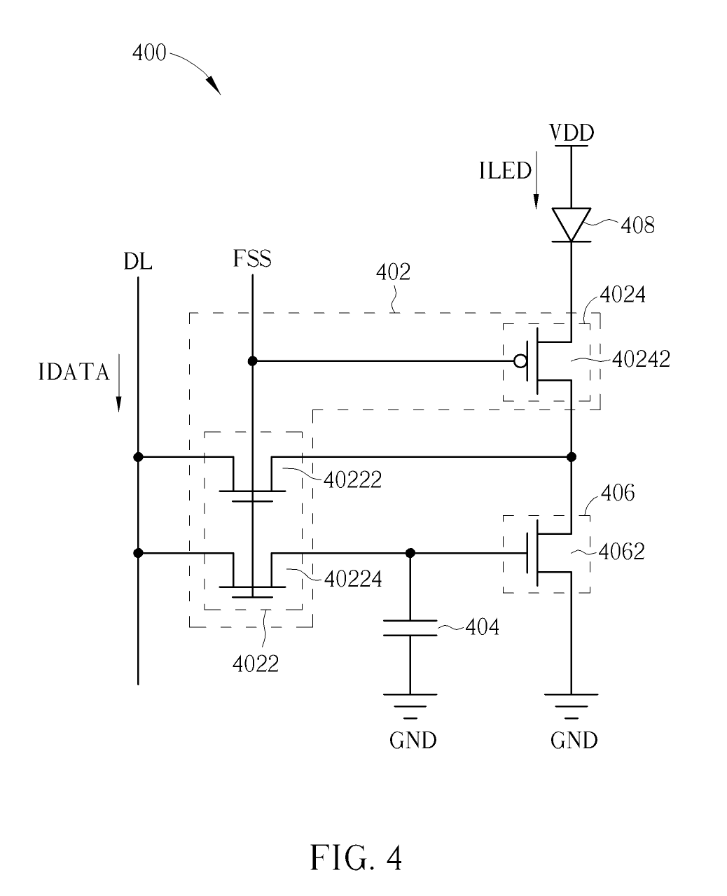

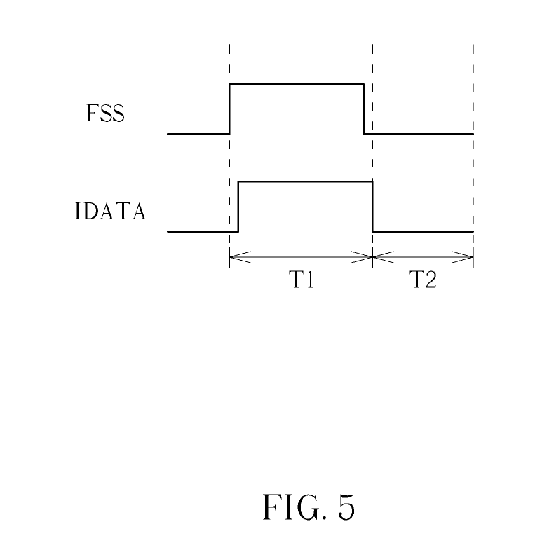

Please refer to FIG. 4 and FIG. 5. FIG. 4 is a diagram illustrating a driving circuit 400 of an organic light emitting device according to an embodiment, and FIG. 5 is a diagram illustrating an operation timing of the driving circuit 400, where the driving circuit 400 is a driving circuit capable of current programming. As shown in FIG. 4, the driving circuit 400 includes a switch module 402, a capacitor 404, and a driving unit 406. The switch module 402 includes a first switch unit 4022 and a second switch unit 4024. The first switch unit 4022 is coupled to a data line DL. The second switch unit 4024 is coupled to an organic light emitting device 408, where the organic light emitting device 408 can be an organic light-emitting diode. As shown in FIG. 5, during a programming period (a period T1), the first switch unit 4022 is turned on and the second switch unit 4024 is turned off; during an emission period (period T2), the first switch unit 4022 is turned off and the second switch unit 4024 is turned on. The capacitor 404 is coupled to the first switch unit 4022 for being charged to a data voltage VDATA according to a data current IDATA of a data line DL during the programming period. The driving unit 406 is coupled to the capacitor 404 and the second switch unit 4024 for generating a driving current ILED to drive the organic light emitting device 408 according to the data voltage VDATA during the emission period.

As shown in FIG. 4, the first switch unit 4022 includes a first transistor 40222 and a second transistor 40224. The first transistor 40222 has a first terminal coupled to the data line DL, a second terminal for receiving a first scan signal FSS, and a third terminal. The second transistor 40224 has a first terminal coupled to the data line DL, a second terminal for receiving the first scan signal FSS, and a third terminal coupled to a first terminal of the capacitor 404, where a second terminal of the capacitor 404 is coupled to ground GND, and the first scan signal FSS is a pulse width modulation signal. The second switch unit 4024 includes a third transistor 40242. The third transistor 40242 has a first terminal coupled to a first terminal of the organic light emitting device 408, a second terminal for receiving the first scan signal FSS, and a third terminal coupled to the third terminal of the first transistor 40222, where a second terminal of the organic light emitting device 408 is used for receiving a voltage VDD, and the third transistor 40242 can be a P-type amorphous silicon (A-Si) thin film transistor, a P-type polysilicon (Poly-Si) thin film transistor, a P-type low temperature polysilicon (LTPS) thin film transistor, a P-type organic thin film transistor (OTFT), or a P-type metal oxide thin film transistor (Oxide TFT). The driving unit 406 includes a fourth transistor 4062, where the fourth transistor 4062 has a first terminal coupled to the third terminal of the third transistor 40242, a second terminal coupled to the third terminal of the second transistor 40224, and a third terminal coupled to the ground GND. As shown in FIG. 4, the first transistor 40222, the second transistor 40224, the fourth transistor 4062 are N-type amorphous silicon thin film transistors, N-type polysilicon thin film transistors, N-type low temperature polysilicon thin film transistors, N-type organic thin film transistors, or N-type metal oxide thin film transistors.

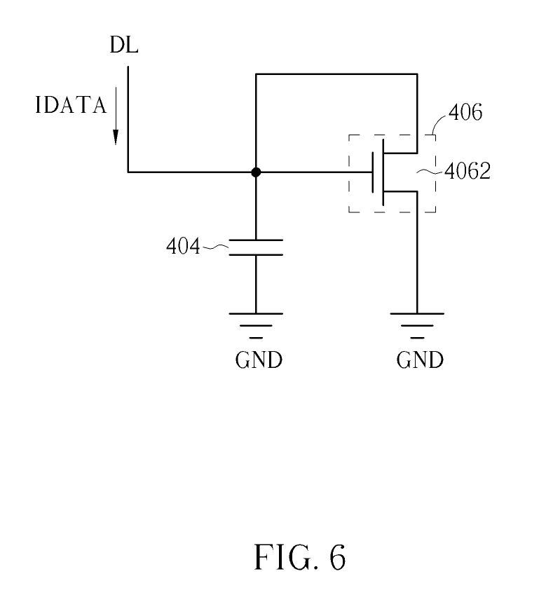

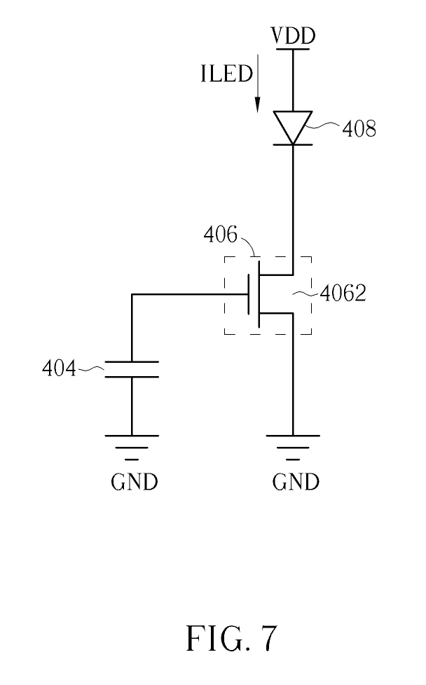

Please refer to FIG. 6 and FIG. 7. FIG. 6 is a diagram illustrating an equivalent circuit of the driving circuit 400 during the programming period, and FIG. 7 is a diagram illustrating an equivalent circuit of the driving circuit 400 during the emission period. As shown in FIG. 5 and FIG. 6, during the programming period (the period T1), the first scan signal FSS is enabled, so the first transistor 40222 and the second transistor 40224 of the first switch unit 4022 are turned on, and the third transistor 40242 of the second switch unit 4024 is turned off, resulting in the first terminal and the second terminal of the fourth transistor 4062 being short-circuited (that is, the fourth transistor 4062 is formed a diode-connected transistor). Therefore, as shown in FIG. 6, the capacitor 404 can be charged to the data voltage VDATA according to the data current IDATA and equation (2):

$$VDATA = \sqrt{\frac{IDATA}{K}} + VTH = VGS \qquad ( 2 )$$

As shown in equation (2), the data voltage VDATA is equal to a voltage drop VGS between the second terminal and the third terminal of the fourth transistor 4062, K is process parameter of the fourth transistor 4062, and VTH is a threshold voltage of the fourth transistor 4062.

As shown in FIG. 5 and FIG. 7, during the emission period (the period T2), the first scan signal FSS is disabled, so the first transistor 40222 and the second transistor 40224 of the first switch unit 4022 are turned off, and the third transistor 40242 of the second switch unit 4024 is turned on. Therefore, as shown in FIG. 7, the fourth transistor 4062 of the driving unit 406 can generate the driving current ILED to drive the organic light emitting device 408 according to the data voltage VDATA, where the driving current ILED is determined by equation (3):

ILED=K(VGS−VTH)² (3)

The voltage drop VGS between the second terminal and the third terminal of the fourth transistor 4062 in equation (2) can be substituted into equation (3) to yield equation (4):

$$\begin{matrix}ILED = {K ( VGS - VTH )}^{2} \\ = {K ( ( \sqrt{\frac{IDATA}{K}} + VTH ) - VTH )}^{2} \\ = IDATA\end{matrix} \qquad ( 4 )$$

As shown in equation (4), the driving current ILED is equal to the data current ILED, and is independent of any process parameter of the fourth transistor 4062.

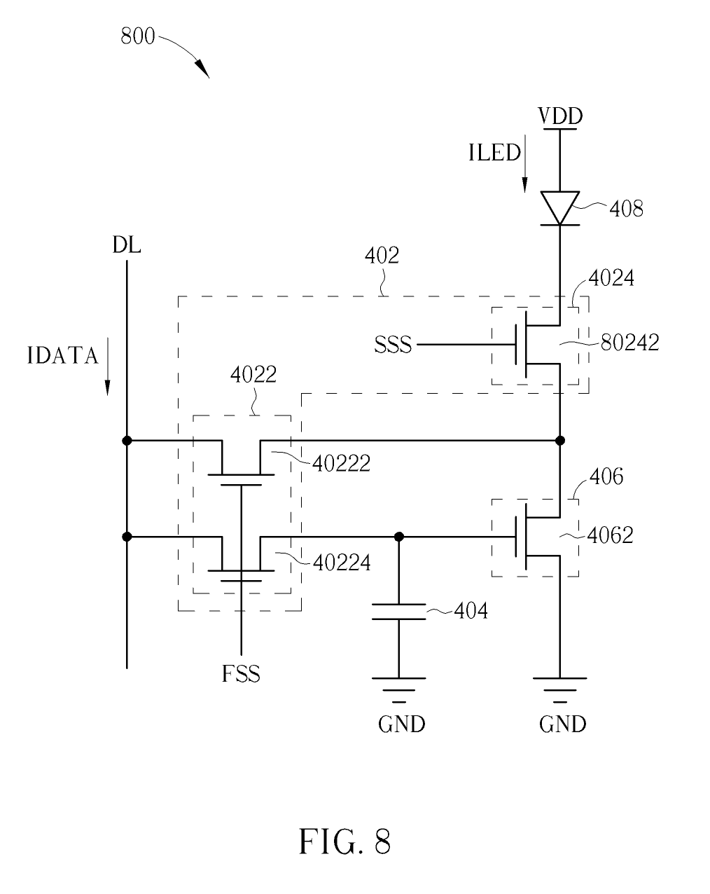

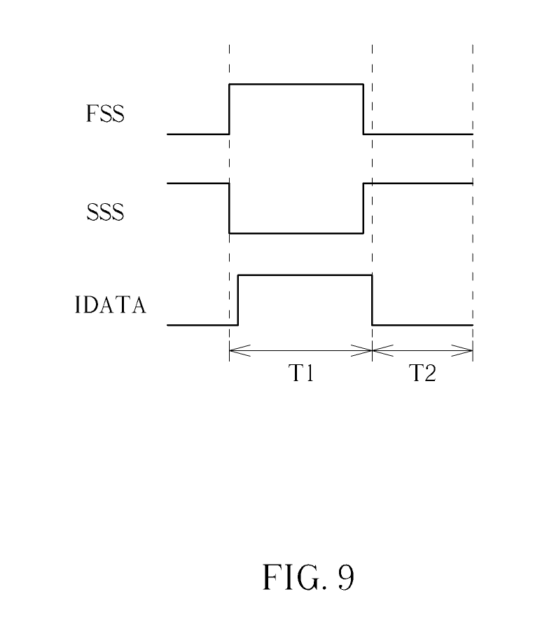

Please refer to FIG. 8 and FIG. 9. FIG. 8 is a diagram illustrating a driving circuit 800 of an organic light emitting device according to another embodiment, and FIG. 9 is a diagram illustrating an operation timing of the driving circuit 800. As shown in FIG. 8, a difference between the driving circuit 800 and the driving circuit 400 is that the second switch unit 4024 includes a third transistor 80242. The third transistor 80242 has a first terminal coupled to the first terminal of the organic light emitting device 408, a second terminal for receiving a second scan signal SSS, and a third terminal coupled to the third terminal of the first transistor 40222, where a phase of the first scan signal FSS is opposite to a phase of the second scan signal SSS, the first scan signal FSS and the second scan signal SSS are pulse width modulation signals, and the third transistor 80242 can be an N-type amorphous silicon thin film transistor, an N-type polysilicon thin film transistor, an N-type low temperature polysilicon thin film transistor, an N-type organic thin film transistor, or an N-type metal oxide thin film transistor. As shown in FIG. 9, during a programming period (a period T1), the first scan signal FSS is enabled and the second scan signal SSS is disabled; during an emission period (a period T2), the first scan signal FSS is disabled and the second scan signal SSS is enabled. Further, subsequent operational principles of the driving circuit 800 are the same as those of the driving circuit 400, so further description thereof is omitted for simplicity.

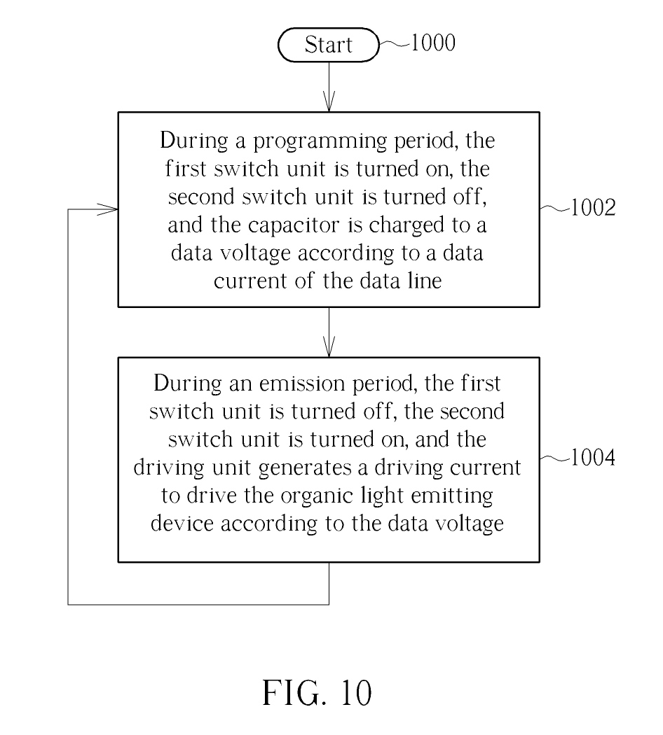

Please refer to FIG. 4, FIG. 5, FIG. 6, FIG. 7, FIG. 8, FIG. 9, and FIG. 10. FIG. 10 is a flowchart illustrating a method of operating a driving circuit of an organic light emitting device according to another embodiment. The method in FIG. 10 is illustrated using the driving circuit 400 in FIG. 4 and the driving circuit 800 in FIG. 8. Detailed steps are as follows:

Step 1000: Start.

Step 1002: During a programming period, the first switch unit 4022 is turned on, the second switch unit 4024 is turned off, and the capacitor 404 is charged to a data voltage VDATA according to a data current IDATA of the data line DL.

Step 1004: During an emission period, the first switch unit 4022 is turned off, the second switch unit 4024 is turned on, and the driving unit 406 generates a driving current ILED to drive the organic light emitting device 408 according to the data voltage VDATA; go to Step 1002.

Taking FIG. 4, FIG. 5, FIG. 6, and FIG. 7 as an example:

In Step 1002, as shown in FIG. 5 and FIG. 6, during the programming period (the period T1), the first scan signal FSS is enabled, so the first transistor 40222 and the second transistor 40224 of the first switch unit 4022 are turned on, and the third transistor 40242 of the second switch unit 4024 is turned off, resulting in the first terminal and the second terminal of the fourth transistor 4062 being short-circuited, where the third transistor 40242 can be a P-type thin film transistor. Therefore, as shown in FIG. 6, the capacitor 404 can be charged to the data voltage VDATA according to the data current IDATA and equation (2). In Step 1004, as shown in FIG. 5 and FIG. 7, during the emission period (the period T2), the first scan signal FSS is disabled, so the first transistor 40222 and the second transistor 40224 of the first switch unit 4022 are turned off, and the third transistor 40242 of the second switch unit 4024 is turned on. Therefore, as shown in FIG. 7, the fourth transistor 4062 of the driving unit 406 can generate the driving current ILED to drive the organic light emitting device 408 according to the data voltage VDATA, where the driving current ILED is determined by equation (3), and as shown in equation (4), the driving current ILED is equal to the data current IDATA.

Taking FIG. 8 and FIG. 9 as an example:

In Step 1002, as shown in FIG. 8 and FIG. 9, during the programming period (the period T1), the first scan signal FSS is enabled and the second scan signal SSS is disabled, so the first transistor 40222 and the second transistor 40224 of the first switch unit 4022 are turned on, and the third transistor 80242 of the second switch unit 4024 is turned off, resulting in the first terminal and the second terminal of the fourth transistor 4062 being short-circuited, where the third transistor 80242 can be an N-type thin film transistor. Therefore, the capacitor 404 can be charged to the data voltage VDATA according to the data current IDATA and equation (2). In Step 1004, as shown in FIG. 8 and FIG. 9, during the emission period (the period T2), the first scan signal FSS is disabled and the second scan signal SSS is enabled, so the first transistor 40222 and the second transistor 40224 of the first switch unit 4022 are turned off, and the third transistor 80242 of the second switch unit 4024 is turned on. Therefore, the fourth transistor 4062 of the driving unit 406 can generate the driving current ILED to drive the organic light emitting device 408 according to the data voltage VDATA.

To sum up, the driving circuit of an organic light emitting device and the method operating the driving circuit of the organic light emitting device utilize the current programming to make the driving current generated by the driving circuit during the emission period be equal to the data current, and be independent of any process parameter of the fourth transistor. Because the driving current generated by the driving circuit during the emission period is equal to the data current and is independent of any process parameter of the fourth transistor, the present invention has advantages as follows: first, the present invention can compensate a threshold voltage shift of the fourth transistor of the driving circuit; second, the present invention can compensate an aging problem of the organic light emitting device; third, the present invention can compensate carrier mobility non-uniformity of a thin film transistor of the driving circuit; and fourth, the present invention can compensate voltage attenuation of a power line coupled to the organic light emitting device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit of an organic light emitting device, the driving circuit comprising:
a switch module comprising:
a first switch unit for coupling to a data line; and
a second switch unit for coupling to the organic light emitting device, wherein the first switch unit is turned on and the second switch unit is turned off during a programming period; and the first switch unit is turned off and the second switch unit is turned on during an emission period;
a capacitor coupled to the first switch unit for being charged to a data voltage according to a data current of the data line during the programming period; and
a driving unit coupled to the capacitor and the second switch unit for generating a driving current to drive the organic light emitting device according to the data voltage during the emission period.

2. The driving circuit of claim 1, wherein the first switch unit comprises:
a first transistor having a first terminal coupled to the data line, a second terminal for receiving a first scan signal, and a third terminal; and
a second transistor having a first terminal coupled to the data line, a second terminal for receiving the first scan signal, and a third terminal coupled to the first terminal of the capacitor, wherein a second terminal of the capacitor is coupled to ground.

3. The driving circuit of claim 2, wherein the second switch unit comprises:
a third transistor having a first terminal coupled to a first terminal of the organic light emitting device, a second terminal for receiving the first scan signal, and a third terminal coupled to the third terminal of the first transistor, wherein a second terminal of the organic light emitting device is used for receiving a voltage.

4. The driving circuit of claim 3, wherein the third transistor is a P-type amorphous silicon (A-Si) thin film transistor, a P-type polysilicon (Poly-Si) thin film transistor, a P-type low temperature polysilicon (LTPS) thin film transistor, a P-type organic thin film transistor (OTFT), or a P-type metal oxide thin film transistor (oxide TFT).

5. The driving circuit of claim 3, wherein the driving unit comprises:
a fourth transistor having a first terminal coupled to the third terminal of the third transistor, a second terminal coupled to the third terminal of the second transistor, and a third terminal coupled to the ground.

6. The driving circuit of claim 5, wherein the data voltage is a voltage drop between the second terminal and the third terminal of the fourth transistor.

7. The driving circuit of claim 5, wherein the data voltage is generated according to the following equation:
$$VDATA = \sqrt{\frac{IDATA}{K}} + VTH ;$$
wherein:
VDATA is the data voltage;
IDATA is the data current;
K is a process parameter of the fourth transistor; and
VTH is a threshold voltage of the fourth transistor.

8. The driving circuit of claim 5, wherein the driving current is equal to the data current.

9. The driving circuit of claim 5, wherein the first transistor, the second transistor, the fourth transistor are N-type amorphous silicon thin film transistors, N-type polysilicon thin film transistors, N-type low temperature polysilicon thin film transistors, N-type organic thin film transistors, or N-type metal oxide thin film transistors.

10. The driving circuit of claim 2, wherein the second switch unit comprises:
a third transistor having a first terminal coupled to a first terminal of the organic light emitting device, a second terminal for receiving a second scan signal, and a third terminal coupled to the third terminal of the first transistor, wherein a second terminal of the organic light emitting device is used for receiving a voltage, and a phase of the first scan signal is opposite to a phase of the second scan signal.

11. The driving circuit of claim 10, wherein the third transistor is an N-type amorphous silicon thin film transistor, an N-type polysilicon thin film transistor, an N-type low temperature polysilicon thin film transistor, an N-type organic thin film transistor, or an N-type metal oxide thin film transistor.

12. The driving circuit of claim 10, wherein the driving unit comprises:
a fourth transistor having a first terminal coupled to the third terminal of the third transistor, a second terminal coupled to the third terminal of the second transistor, and a third terminal coupled to the ground.

13. The driving circuit of claim 12, wherein the data voltage is a voltage drop between the second terminal and the third terminal of the fourth transistor.

14. The driving circuit of claim 12, wherein the data voltage is generated according to the following equation:
$$VDATA = \sqrt{\frac{IDATA}{K}} + VTH ;$$
wherein:
VDATA is the data voltage;
IDATA is the data current;
K is a process parameter of the fourth transistor; and
VTH is a threshold voltage of the fourth transistor.

15. The driving circuit of claim 12, wherein the driving current is equal to the data current.

16. The driving circuit of claim 12, wherein the first transistor, the second transistor, the fourth transistor are N-type amorphous silicon thin film transistors, N-type polysilicon thin film transistors, N-type low temperature polysilicon thin film transistors, N-type organic thin film transistors, or N-type metal oxide thin film transistors.

17. A method of operating a driving circuit of an organic light emitting device, the driving circuit comprising a switch module, a capacitor, and a driving unit, the switch module comprising a first switch unit and a second switch unit, the first switch unit comprising a first transistor and a second transistor, the second switch unit comprising a third transistor, and the driving unit comprising a fourth transistor, the method comprising:
turning on the first switch unit, turning off the second switch unit, and charging the capacitor to a data voltage according to a data current of a data line during a programming period; and
turning off the first switch unit, turning on the second switch unit, and the driving unit generating a driving current to drive the organic light emitting device according to the data voltage during an emission period.

18. The method of claim 17, wherein turning on the first switch unit during the programming period is turning on the first transistor and the second transistor according to a first scan signal.

19. The method of claim. 18, wherein turning off the second switch unit during the programming period is turning off the third transistor according to the first scan signal, wherein the third transistor is a P-type thin film transistor.

20. The method of claim 19, wherein turning off the first switch unit and turning on the second switch unit during the emission period comprises:
turning off the first transistor and the second transistor according to the first scan signal; and
turning on the third transistor according to the first scan signal.

21. The method of claim. 18, wherein turning off the second switch unit during the programming period is turning off the third transistor according to a second scan signal, wherein the third transistor is an N-type thin film transistor, and a phase of the first scan signal is opposite to a phase of the second scan signal.

22. The method of claim 21, wherein turning off the first switch unit and turning on the second switch unit during the emission period comprises:
turning off the first transistor and the second transistor according to the first scan signal; and
turning on the third transistor according to the second scan signal.
